(19) United States
(12) Patent Application Publication
(10) Pub. No.: US 2005/0055704 A1
(43) Pub. Date: Mar. 10, 2005

(54) Device of DISC-rejection pin

(75) Inventor: Jung Tsung Lee, Mingshiung Hsiang (TW)

Correspondence Address: BRUCE H. TROXELL, SUITE 1404, 5205 LEESBURG PIKE, FALLS CHURCH, VA, 22041, US

(73) Assignee: BENQ Corporation

(21) Appl. No.: 10/930,744

(22) Filed: Sep. 1, 2004

(30) Foreign Application Priority Data
Sep. 5, 2003 (TW) 92216044

(51) Int. Cl. G11B 33/02

(52) U.S. Cl. 720/646

(57) ABSTRACT

A device of DISC-rejection-pin placed on the DISC drive, includes a holding device and a pin, wherein the holding device is comprised of two sets of extrusion, and each set of extrusion has two (upper and lower) circular extruding portions, the space between which is smaller than the diameter of the pin, and an appropriate distance between the two sets of extruding portion is smaller than the length of the pin, and the pin is held by the two sets of extruding portion.

### FIELD OF THE INVENTION

The invention relates to a device of DISC-rejection pin, and in particular, to a device of DISC-rejection pin which uses a holding device to hold the DISC-rejection pin on the DISC drive.

### BACKGROUND OF THE INVENTION

Following the continuous progress and development of technology, computer has become an indispensable tool in our modern living. Recently, as the technique of electronic industry is progressing day by day, the application of the DISC drive is also becoming more and more and more popular. Particularly, as a storing device, DISC drive is advancing toward as a high-speed tool; that is, accessing data quickly is badly desired. The DISC drive of double speed appeared few years ago now has become a low-end product already. Today, a DISC drive of forty-eight speed is the most popular product on the market, and, according to the estimation, the one with sixty-four speed will be soon available to the market. Larger the memory size is, larger amount of sound and image files could be stored, the DISC drive has become one of the standard devices in computer.

Please refer to FIG. 1, which shows a DISC drive 1 including: a panel 11, a DISC tray 15, a DISC-rejection hole 16, control buttons 12, an earphone hole 14, a light-emitting diode (LED) light 13. When such DISC driver is disposed with a computer and the computer is on, the power device in the computer will supply electrical power to the DISC drive 1 and enable the DISC driver 1 to operate normally. When a user wants to take out a DISC from the DISC driver 1, he needs to push the control button on the control panel. So, when the user pushes down the control button 12, the DISC will be automatically withdrawn from the DISC drive 1. The light-emitting diode (LED) light 13 is playing a role to indicate the current operation state of the DISC driver 1. The above descriptions are all illustrating the DISC driver working in a normal condition. However, when the computer is down and the power fails, the DISC in the DISC driver 1 will not be removed normal as usual. Therefore, some other mean, such as a pin, may be used to manually insert into the DISC-rejection hole 16 to remove the DISC. However, when such situation happened, he has to find himself an appropriate pin to put into the DISC-rejection hole 16 to remove the DISC. Obviously, it is very inconvenient and the pin is easily lost, so the present invention provides an excellent solution including a pin and a holding device to overcome the inconvenience.

### SUMMARY OF THE INVENTION

The main objective of the present invention is to provide a device of DISC-rejection pin that is available when an urgency of rejection of a DISC is desired.

To achieve aforesaid objective, the device of DISC-rejection pin of the present invention includes: a holding device and a pin. The device of DISC-rejection pin can be used in a DISC drive. The DISC drive includes a panel, a DISC-rejection hole, and a light-emitting diode (LED) light. The holding device is disposed on the DISC drive. The pin is held on the DISC drive by means of the holding device.

The following drawings are cooperated to describe the detailed structure and its connective relationship according to the invention for facilitating your esteemed members of reviewing committee in understanding the characteristics and the objectives of the invention.

### BRIEF DESCRIPTION OF THE DRAWINGS

FIG. 1 is an illustration of a DISC drive. FIG. 2A is an embodiment according to the invention where a DISC drive is cooperated with a device of DISC-rejection pin.

FIG. 2B is an enlarged diagram for the dotted area B in FIG. 2A.

FIG. 3 is a side view of the device of DISC-rejection pin according to the present invention.

FIG. 4 and FIG. 5 are respectively a side view and a 3-D view for another embodiment of the device of DISC-rejection pin according to the present invention.

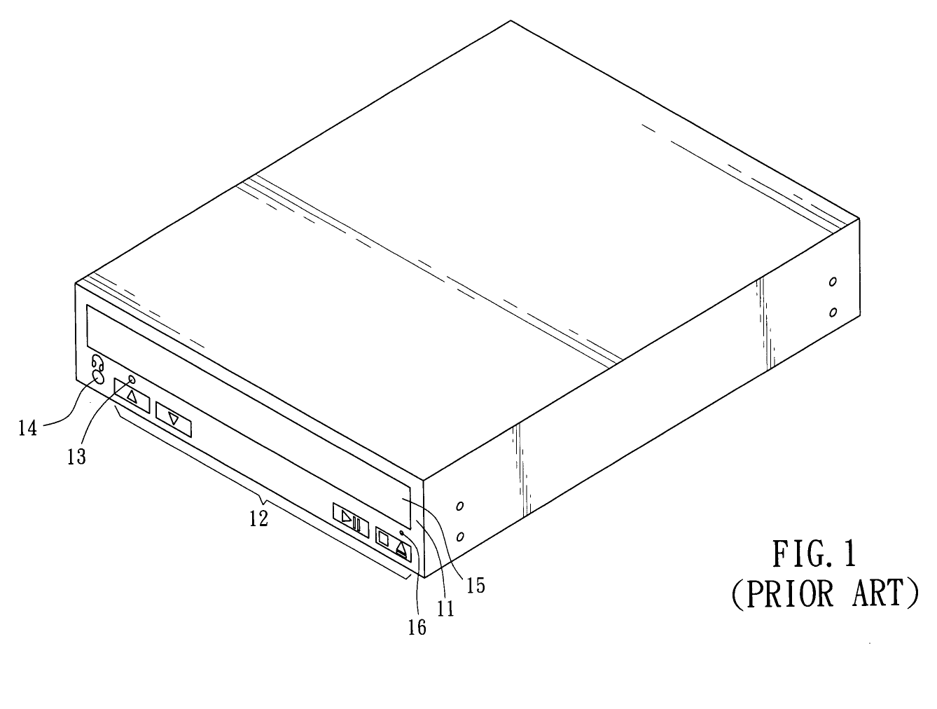

### DETAILED DESCRIPTION OF THE INVENTION

For your esteemed members of reviewing committee to further understand and recognize the fulfilled functions and structural characteristics of the invention, several embodiments cooperating with detailed description are presented as the follows.

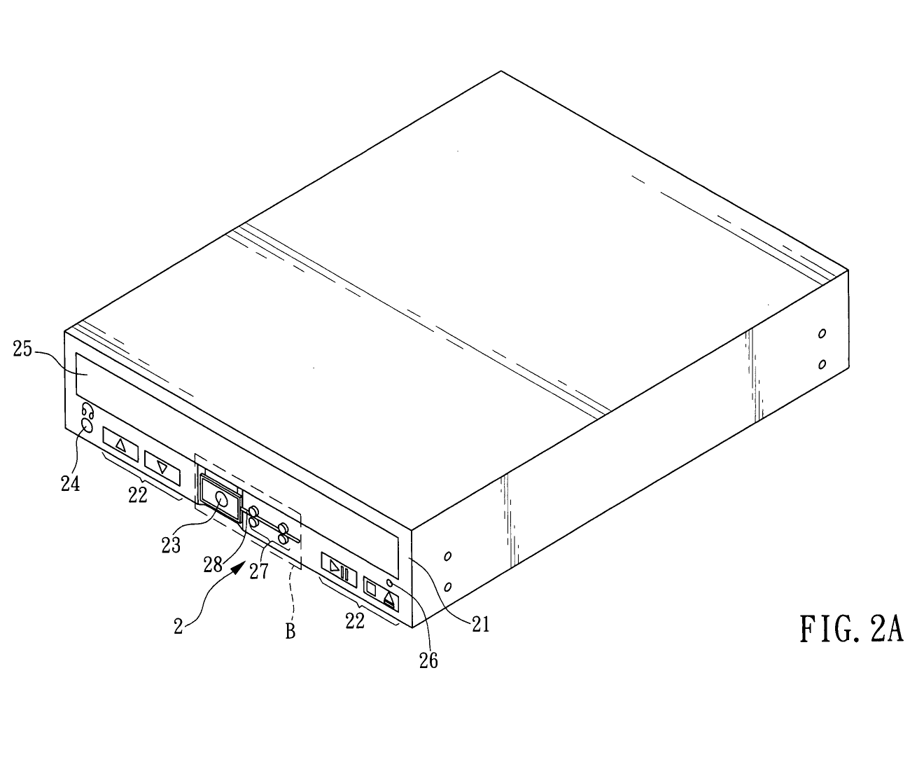

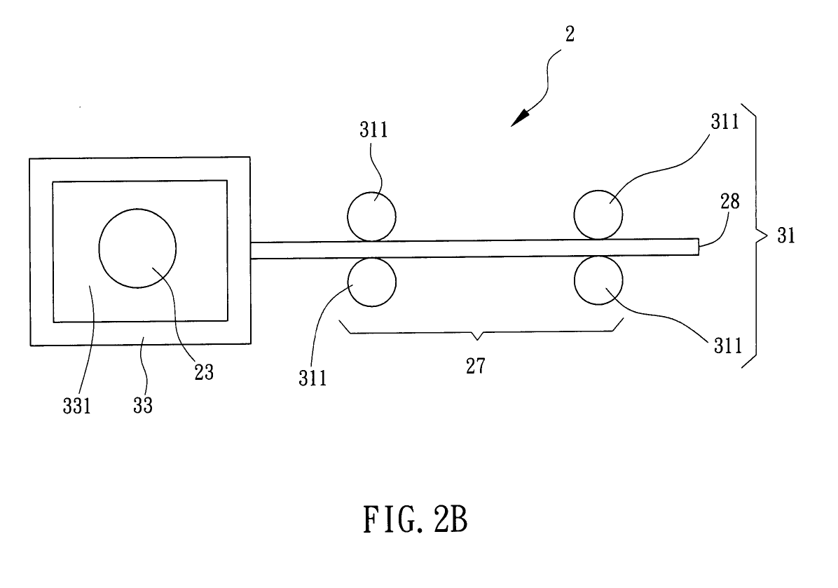

Please refer to FIG. 2A, which is an illustration for the embodiment of a device of DISC-rejection pin according to the present invention. The device of DISC-rejection pin 2 may be arranged on a panel 21 of a DISC drive. The DISC drive includes: a DISC tray 25, a DISC-rejection hole 26, control buttons 22, a earphone hole 24, a light-emitting diode (LED) light 23, and a device of DISC-rejection pin 2.

Please refer to FIG. 2B, which is an enlarged view for the dotted area B in FIG. 2A. This embodiment according to the present invention includes: a pin 28 and a holding device 27.

The pin 28, a cylindrical body having an appropriate length, may just be placed into the DISC-rejection hole 26 to remove out the DISC. One end of the pin 28 has a handle 33. The handle 33 is a rectangular body and a window 331 is formed in the middle of the handle 33. Or, the handle 33 may be made of transparent material. The holding device 27 is comprised of two sets of extrusion 31 and each set of extrusion 31 has two circular extruding portions 311. The space between two (upper and lower) extruding portions is slightly smaller than the diameter of the pin 28. And, the distance between two sets of extrusion 31 is smaller than the length of the pin 28. The circular extruding portions are made of elastic material. The holding device 27 formed by the aforesaid two sets of extrusion wedge the pin 28 therein with the elasticity of the circular extruding portion 311. The window 331 of the pin 28 is placed to the corresponding position of the light-emitting diode (LED) light for the convenience of viewing the situation of the DISC driver.

When the device of DISC-rejection pin is used to remove the DISC from the DISC drive, the handle 33 is gripped by a user and the user will insert the pin 28 into the DISC-rejection hole 26 to remove the DISC. When done, the pin 28 is put back and is wedged in two sets of extrusion 31.

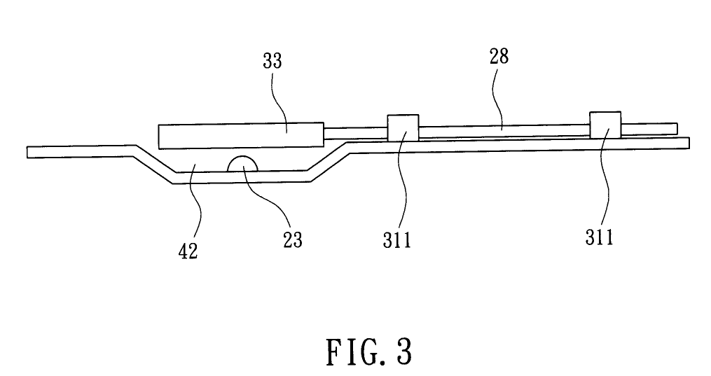

Please refer to FIG. 3, which is a side view for the device of DISC-rejection pin according to the embodiment of the present invention. Wherein a groove 42 is arranged in the handle 33 of the pin 28 corresponding to the panel. The groove 42 provides the convenience for the user to grip the pin 28.

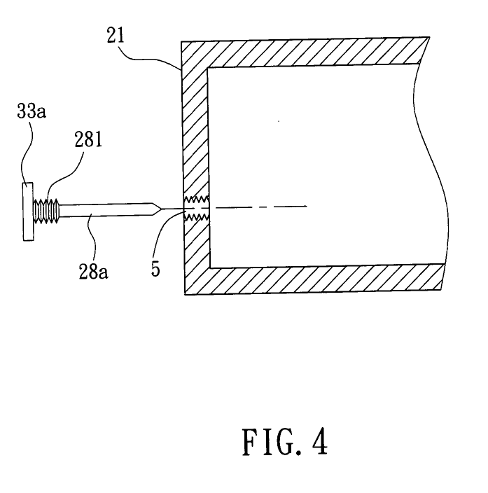

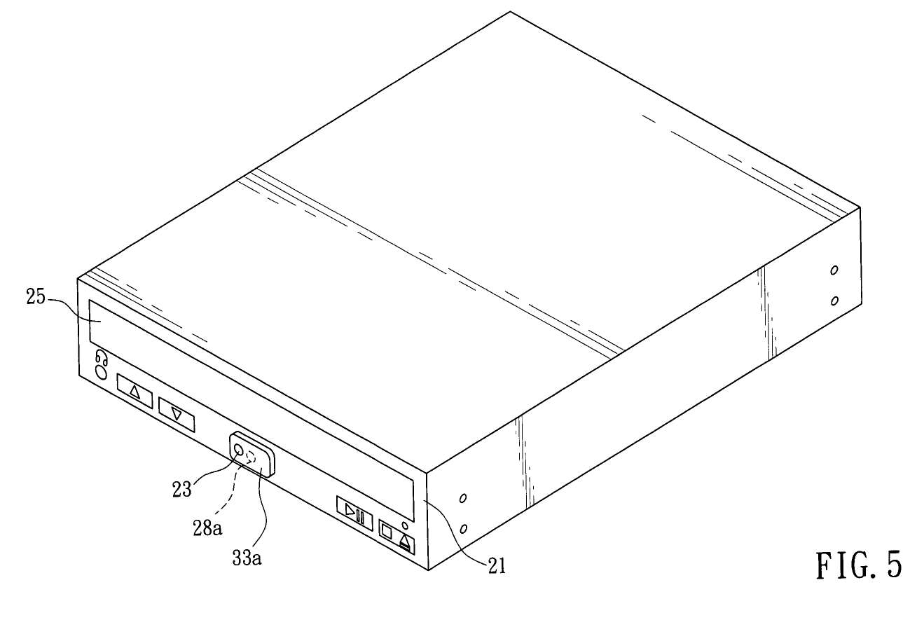

Please refer to FIG. 4 and FIG. 5, which are respectively a side view and a 3-D view for another embodiment where a device of DISC-rejection pin of the present invention is used in a DISC drive. The device of DISC-rejection pin includes: a threaded hole 5 and a pin 28a. The pin 28a has a handle 33a and thread 281. The threaded hole 5 is arranged on the panel 21 of the DISC drive and is able to accommodate the pin 28a and the handle 33a of the pin 28a is extruding out from the panel 21. The handle 33a is made of transparent material and will not block the user's vision from observing the indication of the light-emitting diode light 23. When the pin 28a is inserted into the threaded hole 5, the threaded hole 5 and the thread 281 may function to hold the pin 28a. And, since the handle 33a of the pin 28a is extruding out of the panel 21, so the pin 28a is easy for using. Therefore, the thread 281 on the pin 28a and the threaded hole 5 on the panel 21 are cooperated to hold the pin 28a. Obviously, the main objective of the threaded hole 5 is to provide a holding hole to hold the pin on the panel of the DISC drive. Of course, other modification of holding can be made to hold the pin, it is all within the scope of the present invention, extra description is not necessary to be presented here any more.

However, the aforementioned description is only the embodiments according to the invention and, of course, can not be applied as a limitation to the field of the invention, and any equivalent variation and modification made according to the claims claimed thereinafter still possess the merits of the invention and are still within the spirits and the ranges of the invention, so they should be deemed as a further executing situation of the invention.

1. A DISC drive having a device of DISC-rejection pin at least includes:
a panel, on which a DISC-rejection hole is arranged;
a pin, which may be placed into the DISC-rejection hole to function a DISC-rejection process; and
a holding device arranged at the DISC drive is used for holding the pin to the DISC drive in a detachable manner.

2. The DISC drive according to claim 1, wherein the DISC drive further has a light-emitting diode (LED) light, which is arranged on the panel and is used for indicating the operation situation of the DISC drive.

3. The DISC drive according to claim 1, wherein the pin is a cylindrical body having an appropriate length, and one end of the pin has a handle, and the handle further has a window.

4. The DISC drive according to claim 3, wherein the holding device is comprised of two sets of extrusion, wherein
each set of the extrusion is comprised of two circular extruding portions, the distance between the extruding portion is smaller than the diameter of the pin; and
an appropriate distance is between two sets of extrusion, and the appropriate distance is smaller than the length of the pin, the pin is wedged and held by the two sets of extruding portion, and the window of the handle of the pin is disposed to the corresponding position of a light-emitting diode (LED) light, so that the condition of the light-emitting diode light may be examined.

5. The DISC drive according to claim 3, wherein a portion of the handle of the pin corresponding to the panel has a groove.

6. The DISC drive according to claim 4, wherein the circular extruding portion is made of an elastic material.

7. The DISC drive according to claim 1, wherein the holding device includes a hole disposed on the panel of the DISC drive, and the hole is used for holding the pin.

8. The DISC drive according to claim 7, wherein the hole is a threaded hole, and the pin has threads corresponding to the threaded hole.
